(19) United States
(12) Patent Application Publication
(10) Pub. No.: US 2024/0176329 A1
(43) Pub. Date: May 30, 2024

(54) CONTROL METHOD FOR CASTING MACHINE, CONTROL SYSTEM FOR CASTING MACHINE AND COMPUTER-READABLE STORAGE MEDIUM

(71) Applicant: Aktiebolaget SKF, Göteborg (SE)

(72) Inventors: Jinshi CUI, Shanghai (CN); Kaihuan ZHANG, Hangzhou (CN); Xiaofeng XU, Shanghai (CN)

(21) Appl. No.: 18/508,330

(22) Filed: Nov. 14, 2023

(30) Foreign Application Priority Data
Nov. 24, 2022 (CN) 202211483217.3

(51) Int. Cl. G05B 19/4155

(52) U.S. Cl. CPC G05B 19/4155; G05B 2219/45152

(57) ABSTRACT

A control method for a casting machine is disclosed. A control system for a casting machine and a computer-readable storage medium are also disclosed. The casting machine includes a plurality of roller components and a plurality of motors driving the plurality of roller components to rotate. The motors are in one-to-one correspondence with the roller components. The method includes acquiring, within a preset first detection time interval, a running characteristic signal of each roller component; conducting, based on the running characteristic signal of each roller component, a running difference analysis of the plurality of roller components to obtain a running difference analysis result; conducting, based on the running difference analysis result, control on the casting machine. The running difference analysis includes at least one of a running synchronization analysis and a running similarity analysis.

### CROSS-REFERENCE TO RELATED APPLICATION

This application claims priority to Chinese Application No. 202211483217.3, filed Nov. 24, 2022, the entirety of which is hereby incorporated by reference.

### FIELD

The present disclosure relates to the field of automatic control, in particular to a control method for a casting machine, a control system for a casting machine and a computer-readable storage medium.

### BACKGROUND

With the wide application of billet in civil and commercial fields, there are higher requirements for casting machines, especially billet casting machines.

At present, a casting machine is usually provided with a plurality of closely arranged casting rollers (also called casting flow guide rollers or roller components), and the billet (such as slab) is pulled out at a guide section by the casting rollers, and the surface quality of the finally produced slab is closely related to the running consistency (including time synchronization and running performance synchronization) of the casting rollers. Ideally, the casting rollers in a unit run under the same central control system, and the operation and characteristics of all the casting rollers should be consistent. However, in an actual operation process, there are differences in the running characteristics and running cycle of the casting rollers, which will lead to uneven slab quality. At present, the control system for casting machines lacks the detection and maintenance technology regarding the running difference between multiple casting rollers, and it is impossible to realize detection of the running difference of multiple casting rollers.

Therefore, there is a need for a solution, which under the premise of good control of the casting machine, is capable of analyzing and processing the running difference of multiple roller components of a casting machine in real time, so that the multiple roller components have good running synchronization and running similarity, and the produced billet has good quality.

### SUMMARY

In view of the above problems, the present disclosure provides a control method for a casting machine, a control system for a casting machine and a computer-readable storage medium. By using the control method for a casting machine provided by the present disclosure, it is possible that on the premise of realizing good control of the casting machine, the running differences of a plurality of roller components of the casting machine can be analyzed and processed in real time, so that the plurality of roller components have good running synchronization and running similarity, and the produced billet has good quality.

According to an aspect of the present disclosure, a control method for a casting machine is proposed, the casting machine comprising a plurality of roller components and a plurality of motors driving the plurality of roller components to rotate, wherein the motors are in one-to-one correspondence with the roller components, and the method comprises: acquiring, within a preset first detection time interval, a running characteristic signal of each roller component; conducting, based on the running characteristic signal of each roller component, a running difference analysis of the plurality of roller components to obtain a running difference analysis result; conducting, based on the running difference analysis result, control on the casting machine; wherein the running difference analysis comprises at least one of a running synchronization analysis and a running similarity analysis.

In some embodiments, the running characteristic signal of a roller component comprises a running torque signal of the roller component and a rotational speed signal of the roller component.

In some embodiments, the running synchronization analysis comprises: for each of the plurality of roller components, analyzing the running characteristic signal of the roller component in time domain to determine running time domain deviation data of the roller component; determining, based on the running time domain deviation data of the roller component and a preset deviation threshold, a running synchronization state of the roller component to obtain a synchronization analysis result; and wherein the running synchronization state is a normal synchronization state or an abnormal synchronization state.

In some embodiments, the running similarity analysis comprises: for each of the plurality of roller components, performing a waveform analysis on the running characteristic signal of the roller component to determine running similarity data of the roller component; determining, based on the running similarity data of the roller component and a preset similarity threshold, a running similarity state of the roller component to obtain a similarity analysis result; and wherein the running similarity state is a normal similarity state or an abnormal similarity state.

In some embodiments, the control method of a casting machine further comprises a continuity analysis of roller components: acquiring, after a certain roller component is replaced, in a preset first detection time interval, a running characteristic signal of a replaced roller component; conducting, based on the running characteristic signal of the previous roller component and the running characteristic signal of the replaced roller component, a continuity analysis of the previous roller component and the replaced roller component to obtain a continuity analysis result of roller components.

In some embodiments, conducting control of the casting machine based on the running difference analysis result comprises: generating and sending alarm information where the running difference analysis result indicates that a certain roller component is in an abnormal synchronization state and/or an abnormal similarity state.

In some embodiments, the method further comprises an abnormality detection process, comprising: for at least one of the plurality of roller components, acquiring, within a preset second detection time interval, a running characteristic signal of the roller component; generating, based on the running characteristic signal of the roller component, performance characteristic data of the roller component; comparing the performance characteristic data with a preset performance threshold range, and determining a running performance state of the roller component based on the comparison result; wherein the running performance state comprises a normal running state and an abnormal running state.

In some embodiments, the roller component comprises a plurality of sub-components, and each sub-component further comprises a plurality of sub-composing parts; and the method further comprises a fault diagnosis process, wherein the fault diagnosis process comprises: for at least one of the plurality of roller components, obtaining, within a preset third detection time interval, a running characteristic signal of the roller component; performing spectrum analysis on the running characteristic signal to obtain a plurality of sub-spectrum characteristics corresponding to the running characteristic signal; wherein each sub-spectrum characteristic is associated with a performance state of the corresponding sub-composing part of the roller component; comparing, for each sub-spectrum characteristic, the sub-spectrum characteristic with a preset fault spectrum characteristic range of the corresponding sub-composing part; determining, under a condition where the sub-spectrum characteristic falls within the preset fault spectrum characteristic range, that the sub-component comprising the sub-composing part is in a fault state, and determining a fault type of the sub-component as a fault of the sub-composing part.

According to another aspect of the present disclosure, a control system of a casting machine is proposed, the casting machine comprising a plurality of roller components and a plurality of motors driving the plurality of roller components to rotate, wherein the motors are in one-to-one correspondence with the roller components, and the system comprises a running characteristic acquisition module configured to acquire a running characteristic signal of each roller component within a preset first detection time interval; a running difference analysis module configured to perform a running difference analysis on the plurality of roller components based on the running characteristic signal of each roller component to obtain a running difference analysis result; a casting machine control module configured to conduct control on the casting machine based on the running difference analysis result; wherein the running difference analysis comprises at least one of a running synchronization analysis and a running similarity analysis.

According to another aspect of the present disclosure, a computer-readable storage medium is proposed, characterized in that computer-readable instructions are stored on the computer-readable storage medium, and when the instructions are executed by a computer, the aforementioned method is executed.

### BRIEF DESCRIPTION OF THE DRAWINGS

In order to explain the technical scheme of the embodiments of the present disclosure more clearly, the drawings needed in the description of the embodiments will be briefly introduced below. It is apparent that the drawings in the following description are only some embodiments of the present disclosure. For those of ordinary skills in the field, other drawings can be obtained according to these drawings without creative work. The following drawings are not deliberately drawn to the same scale as the actual size, and emphasis is placed on showing the gist of the present disclosure.

FIG. 1 shows an exemplary flowchart of a control method 100 for a casting machine according to an embodiment of the present disclosure;

FIG. 2 shows an exemplary flowchart of the process of a synchronization analysis 102A according to an embodiment of the present disclosure;

FIG. 3 shows an exemplary flowchart of the process of a synchronization analysis 102B according to an embodiment of the present disclosure;

FIG. 4 shows an exemplary flowchart of an abnormality detection process 110 according to an embodiment of the present disclosure;

FIG. 5 shows a schematic flowchart of a fault diagnosis process 120 of a roller component according to an embodiment of the present disclosure; and

FIG. 6 shows an exemplary block diagram of a control system 200 for a casting machine according to an embodiment of the present disclosure.

### DETAILED DESCRIPTION

The technical scheme in the embodiments of the present disclosure will be described clearly and completely with the attached drawings. Apparently, the described embodiments are only a part of the embodiments of the present disclosure, but not all the embodiments. Based on the embodiments of the present disclosure, all other embodiments obtained by those of ordinary skills in the field without creative work also belong to the scope of protection of the present disclosure.

As shown in the present application and claims, unless the context clearly suggests an exception, words “a”, “an” and/or “the” do not specifically refer to the singular, but may also refer to the plural. Generally speaking, terms “comprising” and “including” only imply the inclusion of clearly identified steps and elements, while these steps and elements do not constitute an exclusive list, and a method or device may also include other steps or elements.

Although the present application makes various references to some modules in the system according to the embodiments of the present application, any number of different modules can be used and run on the user terminal and/or the server. The modules are merely illustrative, and different aspects of the system and method may use different modules.

Flowcharts are used in the present application to explain the operations performed by the system according to the embodiments of the present application. It should be understood that the preceding or following operations are not necessarily performed accurately in order. On the contrary, various steps can be processed in reverse order or at the same time, as required. Meanwhile, other operations can be added to these processes, or one or more steps can be removed from these processes.

According to an aspect of the present disclosure, a control method 100 for a casting machine is proposed. The control method for a casting machine is a method for realizing the control of a casting machine. The casting machine refers to the equipment used to continuously cast high-temperature molten steel into billets with a certain cross-sectional shape and a certain size specification.

For example, the casting machine may include, for example, a plurality of roller components, and a plurality of motors that drive the plurality of roller components to rotate, and the motors are in one-to-one correspondence to the roller components.

The plurality of roller components, closely arranged, pull the billet out at a guide section of the casting machine, and the surface quality of the finally produced slab is closely related to the running consistency (including time synchronization and running performance synchronization) of the plurality of casting rollers.

It should be understood that in addition to the roller components, and according to actual needs, the casting machine in the present application can also include, for example, steel pouring equipment, casting machine body equipment, cutting area equipment, collecting and conveying equipment, etc., so as to realize the process of billet casting and cutting.

FIG. 1 shows an exemplary flowchart of a control method 100 for a casting machine according to an embodiment of the present disclosure.

Referring to FIG. 1, in step S101, a running characteristic signal of each roller component is acquired within a preset first detection time interval.

It should be understood that the preset first detection time interval refers to a preset time period for realizing roller detection, and the preset first detection time interval can be selected by the user according to actual needs or preset by the system, for example. The embodiments of the present disclosure is not limited by the specific duration of the preset first detection time interval.

For example, it can be set that the preset first detection time interval is 15 minutes, and that a next detection is conducted at an interval of five minutes after the first detection. Alternatively, it can be set that the operation of the casting machine is continuously detected during the working process of the casting machine.

The running characteristic signal of the roller component refers to a signal used to reflect the running state of the roller component. The running characteristic signal can be, for example, a signal of the torque subjected to by the roller component, or a rotational speed signal of the roller component, and can also include other signals according to actual needs.

The running characteristic signal may be, for example, a voltage or current signal, or may be other types of signals. The embodiments of the present disclosure is not limited by the acquisition approach and type of the running characteristic signal.

After obtaining the running characteristic signal of each roller component, in step S102, based on the running characteristic signal of each roller component, a running difference analysis of the plurality of roller components is conducted to obtain a running difference analysis result.

The running difference analysis refers to an analysis of the running difference of the plurality of roller components, which aims to know whether the plurality of roller components have good running consistency (including time synchronization and/or running performance similarity) at present, which can include, for example, a running synchronization analysis and/or a running difference analysis, and can also include other analysis contents related to the running difference of the roller components according to actual needs.

The running difference analysis result can indicate the roller components which are in inconsistent running state with other roller components, or it can also adopt other forms of expression. The embodiments of the present disclosure is not limited by the specific forms of expression of the running difference analysis result.

After the running difference analysis result is obtained, control is conducted on the casting machine based on the running difference analysis result in step S103.

For example, the running state of the roller components in inconsistent running state can be adjusted based on the running difference analysis result, or corresponding alarm information can be generated based on the running difference analysis result.

The running difference analysis includes, for example, at least one of a running synchronization analysis and a running similarity analysis.

The running synchronization analysis refers to an analysis for determining whether the rotations of the plurality of roller components are consistent in time domain, that is, whether they are synchronized in time. For example, it is judged whether the running time periods of the running characteristic signals of the plurality of roller components are the same, and whether the starting points and ending points of the rotation are basically the same.

The running similarity analysis refers to an analysis used to determine whether the running performances of the plurality of roller components have relatively large similarity, that is, whether the signal waveforms are related. For example, it is judged whether the similarity of the waveforms of the running characteristic signals of the plurality of roller components meets a preset requirement or not.

In the present application, by setting that in a preset first detection time interval, the running characteristic signal of each roller component is obtained, and based on the running characteristic signal of each roller component, the running difference analysis is conducted for the plurality of roller components, the running difference analysis result is obtained so as to conduct control on the casting machine, in the process of conducting control on the casting machine, the influence of the differences of a plurality of roller components during the running process on slab quality is fully considered, so as to enable a flexible and reliable analysis on the running difference of the roller components, thereby adjusting the roller components in time, realizing good and reliable slab production and improving the quality of the produced slab. In addition, by setting that the running difference analysis includes at least one of a running synchronization analysis and a running similarity analysis, in the evaluation of roller running difference, the influence of running performance difference (and running similarity difference) and running time difference (that is, running synchronization difference) during the roller running process on the final slab quality is fully considered, so that various inconsistencies in roller running can be well detected, which is beneficial for timely treatment and adjustment, improving the reliability of the casting machine as well as the quality of the produced billets in all directions.

In some embodiments, the running characteristic signal of a roller component comprises a running torque signal of the roller component and a rotational speed signal of the roller component.

The running torque signal of the roller component refers to the signal representing the magnitude of the torque that the roller component is subjected to in the running process. For example, the running torque signal of the roller component can be characterized by the output torque signal of the motor connected to the roller component.

The rotational speed signal of the roller component refers to the signal representing the magnitude of the rotational speed of the roller component during running. For example, the rotational speed signal may be collected via a sensor disposed near the roller component.

It should be understood that the embodiments of the present disclosure is not limited by the specific acquisition approach of the running characteristic signal of the roller component.

Based on the above, in the present application, by setting that the running characteristic signal of the roller component includes the running torque signal and the rotational speed signal of the roller component, the running characteristic signal can include the force situation and rotational speed situation of the roller component during running, so that the running situation of the roller component can be comprehensively reflected, which is beneficial to improving the accuracy and reliability of the subsequent running difference analysis of the roller component.

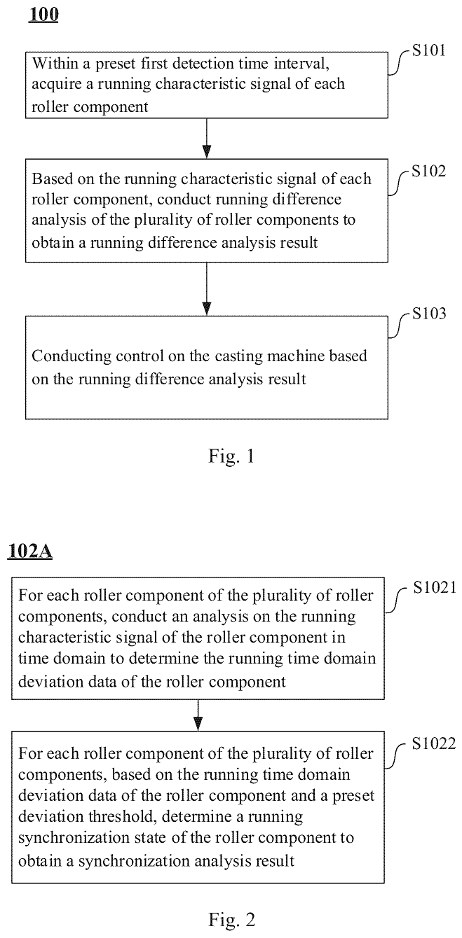

In some embodiments, the running synchronization analysis can be described in more detail, for example. FIG. 2 shows an exemplary flowchart of a process of the synchronization analysis 102A according to an embodiment of the present disclosure.

Referring to FIG. 2, in the synchronization analysis process 102A, firstly, in step S1021, for each roller component of the plurality of roller components, the running characteristic signal of the roller component is analyzed in time domain to determine running time domain deviation data of the roller component.

For example, the running characteristic signal may include, for example, a running torque signal of the roller component.

The time domain analysis refers to a process of conducting analysis on the running characteristic signal of the roller component in the time domain. The present disclosure is not limited by the specific time domain analysis method adopted.

The running time domain deviation data of the roller component refers to the data on the deviation degree of the roller component in the running process compared with other roller components in the time domain, which aims to reflect the inconsistency or deviation degree of the running of the roller component with other rollers with respect to time.

For example, the process of the time domain analysis to determine the running time domain deviation data of the roller component can be described in more detail. For example, first, a reference running signal is acquired, which can be, for example, an average running signal calculated based on the running characteristic signals of all roller components; thereafter, for example, the running signal of each roller component is compared with the reference running signal in the time domain. For example, for the same rotation process (for example, the first rotation process), one or more of the rotation start time, rotation end time and rotation peak time of the roller component and the corresponding rotation start time, rotation end time and rotation peak time of the reference running signal can be compared, so as to obtain the running time domain deviation data.

For example, the time domain deviation data can for example be a deviation rate, and the deviation rate=(actual value−reference value)/reference value*100%. However, it should be understood that the embodiments of the present disclosure are not limited thereto.

After obtaining the running time domain deviation data of each roller component, in step S1022, for each roller component of the plurality of roller components, a running synchronization state of the roller component is determined based on the running time domain deviation data of the roller component and a preset deviation threshold, and the synchronization analysis result is obtained.

The preset deviation threshold is used to define the maximum limit of the running deviation of the roller component. It can be specified by the user, for example, or it can be preset by the system. The embodiments of the present disclosure is not limited by the specific setting approach and specific setting value of the preset deviation threshold.

The running synchronization state is intended to characterize the performance of the roller component in running synchronization with other components.

The running synchronization state is a normal synchronization state or an abnormal synchronization state. The normal synchronization state refers to a state in which the running of the roller component is basically consistent with that of other roller components in the time domain, that is, the synchronous running in the time domain within the error range is satisfied. The abnormal synchronization state refers to a state in which the running of the roller component and that of other roller components are in a time-domain asynchronization state.

For example, the process of determining the running synchronization state of the roller component can be described in more detail. For example, the running time domain deviation data can be compared with a preset deviation threshold; Under a condition where the running time domain deviation data is greater than the preset deviation threshold, the running synchronization state of the roller component is determined as the abnormal synchronization state; Under a condition where the running time domain deviation data is less than the preset deviation threshold, the running synchronization state of the roller component is determined as the normal synchronization state.

For example, when the time domain deviation data is a deviation rate, the preset deviation threshold may be for example a preset deviation rate threshold. And it is set to, for example, 20%. If the time domain deviation data of the running characteristic signal of a certain roller component currently collected is 23%, it is greater than the preset deviation threshold. At this time, for example, the running synchronization state of the roller component can be determined as the abnormal synchronization state.

Based on the above, by further setting that the running synchronization analysis further includes conducting an analysis on the running characteristic signal of the roller component in time domain to determine the running time domain deviation data of the roller component; based on the running time domain deviation data of the roller component and the preset deviation threshold, determining the running synchronization state of the roller component, and obtaining the synchronization analysis result, the running synchronization state of the roller component compared with other roller components can be accurately and reliably determined through time domain analysis, so that the roller component in abnormal synchronization state can be accurately identified, which is beneficial to timely adjustment of the running state of the roller component, thereby improving the time synchronization and reliability of the roller components.

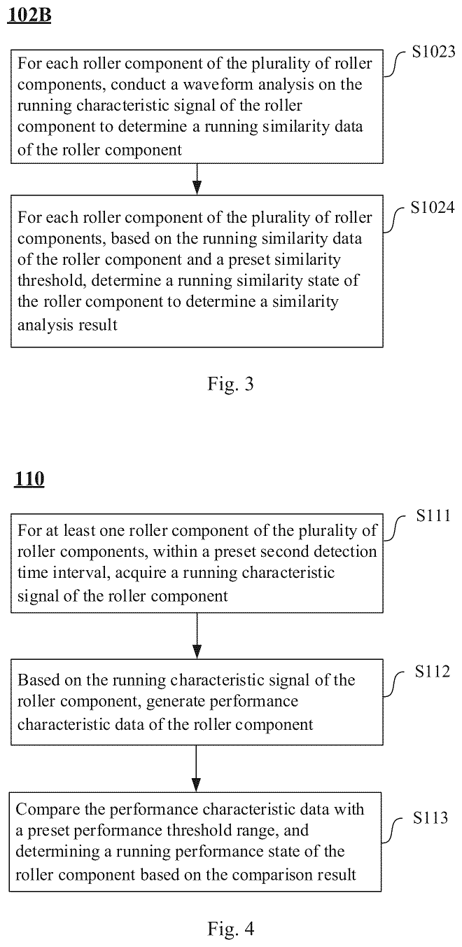

In some embodiments, the running similarity analysis can be described in more detail, for example. FIG. 3 shows an exemplary flowchart of a process of a synchronization analysis 102B according to an embodiment of the present disclosure.

Refer to FIG. 3, in step S1023, for each roller component of the plurality of roller components, a waveform analysis is performed on the running characteristic signal of the roller component to determine the running similarity data of the roller component.

The waveform analysis refers to an analysis on the waveform characteristics of the running characteristic signal of the roller component. For example, the waveform analysis may include, for example, the analysis of the peak value, average value, similarity and other characteristics of the signal waveform.

For example, the running characteristic signal may include, for example, a running torque signal of the roller component.

The running similarity data refers to data representing the running characteristics similarity of the plurality of roller components in the running process, for example, the running characteristics similarity can be reflected by the waveform similarity or other waveform characteristics of the running characteristic signals of the roller components.

It should be understood that the running similarity data can be expressed as a similarity value obtained through a similarity function, for example, or can also be expressed as other types of data. The embodiments of the present disclosure is not limited by the specific expression of the running similarity data.

The process of determining the running similarity data can be described in more detail, for example. For example, for each roller component of a plurality of roller components, the running characteristic signal of the roller component can be obtained, and the waveform analysis of the running characteristic signal of the roller component and the running characteristic signal of other roller components can be conducted. Specifically, for example, the similarity data of the running characteristic signal of the roller component and the running characteristic signal of each of other roller components can be obtained based on the similarity function, and the obtained similarity data are weighted and averaged to obtain the similarity data finally corresponding to the roller component, which similarity data is able to characterize the similarity of the roller component with other roller components with respect to the running characteristics.

For example, if there are four roller components D1, D2, D3 and D4, for example, when determining similarity data for roller component D1, for example, waveform analysis can be conducted on the running characteristic signal S1 of roller component D1, for example, waveform similarity X2 of S1 with respect to running characteristic signal S2 of roller component D2, waveform similarity X3 of S1 with respect to running characteristic signal S3 of roller component D3, and waveform similarity X4 of S1 with respect to running characteristic signal S4 of roller component D4 can be obtained respectively, and the obtained waveform similarities X2, X3 and X4 can be weighted averaged, so as to obtain the final similarity data D1_X.

However, it should be understood that the above only gives an exemplary similarity data calculation method, and other similarity calculation methods can be adopted according to embodiments of the present disclosure, such as processing the running characteristic signals of each roller component via a preset algorithm or processing function, and outputting the similarity of the roller components. The embodiments of the present disclosure is not limited by the specific analysis approach of the waveform analysis.

Then, in step S1024, for each roller component of the plurality of roller components, a running similarity state of the roller component is determined based on the running similarity data of the roller component and the preset similarity threshold, and a similarity analysis result is obtained.

The preset similarity threshold refers to the maximum limit used to define the deviation of the running performance of the roller components. It can be specified by the user, for example, or it can be preset by the system. The embodiments of the present disclosure is not limited by the specific setting approach and specific setting value of the preset similarity threshold.

The running similarity state is intended to represent the level of consistency of the roller component with other components in running performance. For example, whether they basically run at the same speed, whether they have the same speed change and speed peak value, etc. The consistency of the running performance is for example related to the waveform similarity of the running characteristic signal of the roller component.

The running similarity state is a normal similarity state or an abnormal similarity state.

The normal similarity state refers to a state in which the running of the roller component is basically consistent with that of other roller components, that is, it meets almost the same running performance (such as rotational speed, rotational speed change rate, etc.) within the error range. The abnormal synchronization state refers to a state in which the running performance of the roller component is inconsistent with that of other roller components.

For example, the process of determining the running similarity state of the roller component can be described in more detail. For example, the running similarity data can be compared with a preset similarity threshold; Under a condition where the running similarity data is greater than a preset similarity threshold, the running similarity state of the roller component is determined as a normal similarity state; under a condition where the running similarity data is less than the preset similarity threshold, the running similarity state of the roller component is determined as an abnormal similarity state.

For example, the preset similarity threshold is set to 0.7, and if the running similarity data of the running characteristic signal of a certain roller component currently collected is 0.9, it is greater than the preset similarity threshold. At this time, for example, the running similarity state of the roller component can be determined as a normal similarity state. If the running similarity data of the running characteristic signal of a certain roller component currently collected is 0.6, which is less than the preset similarity threshold, for example, the running similarity state of the roller component is determined as an abnormal similarity state.

It should be understood that the running similarity analysis and the running synchronization analysis can be performed sequentially, reversely or in parallel, for example. The embodiments of the present disclosure is not limited by the specific execution order of the running similarity analysis and the running synchronization analysis.

Base on that above, by setting that the running similarity analysis further comprises the follow steps: for each roller component of the plurality of roller components, conducting a waveform analysis on the running characteristic signal of the roller component to determine the running similarity data of the roller component; based on the running similarity data of the roller component and the preset similarity threshold, determining the running similarity state of the roller component, and obtaining the similarity analysis result, the state of the roller component in terms of running performance consistency compared with other roller components can be accurately and reliably determined through the waveform analysis of the signal, so that the roller component in an abnormal similarity state can be accurately identified, which is beneficial to timely adjust the running state of the roller component, thereby improving the running synchronization and reliability of the roller component.

In some embodiments, the control method for a casting machine further includes a continuity analysis of roller components.

The continuity analysis of roller components refers to the process of analyzing whether the replaced roller component and the previous roller component have consistency in running performance after a roller component of the casting machine is replaced.

For example, the continuity analysis of roller components includes: after a roller component is replaced, the running characteristic signal of the replaced roller component is acquired within a preset first detection time interval; based on the running characteristic signal of the previous roller component and the running characteristic signal of the replaced roller component, the continuity analysis of the previous roller component and the replaced roller component is conducted, and the continuity analysis result of roller components is obtained.

It should be understood that the continuity analysis of roller components includes, for example, the aforementioned waveform analysis, or it may also include the analysis of the rotation period of the roller component in the time domain. Embodiments of the present disclosure are not limited by the specific composition of the continuity analysis of roller components.

For example, suppose a roller component D1 was previously installed at a certain position of the casting machine, it was subsequently replaced with a roller component D5 because this roller component D1 was damaged or reached its service life, and the roller component D1 and the roller component D5 can be, for example, the same type of rollers manufactured by the same manufacturer or different types of rollers manufactured by different manufacturers.

At this time, in order to ensure the quality of the produced slab, it is necessary that the updated roller component D5 has approximately the same running performance as the previous roller component D1. At this time, for example, the running characteristic signal S5 of the roller component D5 in the preset first detection time interval can be collected first, and then the running characteristic signal S5 of the roller component D5 can be compared with the running characteristic signal S1 detected from the previous roller component D1 in the previous preset detection interval. For example, the running characteristic signal S1 of the roller component D1 and the running characteristic signal S5 of the roller component D5 in a single roller rotation process can be compared for a rotation period difference, so as to generate a roller period difference analysis result; the running characteristic signal S1 of the roller component D1 and the running characteristic signal S5 of the roller component D5 can also be obtained for a running similarity state, so as to obtain a similarity analysis result, and a final continuity analysis result is generated based on the similarity analysis result and the period difference analysis result.

For example, the rotation period difference between the running characteristic signal S1 of the roller component D1 and the running characteristic signal S5 of the roller component D5 during a single roller rotation can be compared with a preset period difference threshold, and the roller component D5 can be determined as in an abnormal period state if the rotation period difference is larger than the preset period difference threshold. Furthermore, the running similarity data of the running characteristic signal S1 of the roller component D1 and the running characteristic signal S5 of the roller component D5 can be compared with a preset similarity threshold, and when the running similarity data is less than the preset similarity threshold, the roller component D5 can be determined as in an abnormal similarity state.

And the process of obtaining the continuity analysis result can be, for example, when the roller component D5 is determined to be in any one of an abnormal period state and an abnormal similarity state, determining the continuity analysis result as an abnormal continuity state, which indicates that the replaced roller component is in an inconsistent state with the previous roller component in running performance.

Based on the above, in the present application, by setting that the control method of a casting machine further includes the continuity analysis of roller components, that is, after a roller component is replaced, within the preset first detection time interval, the running characteristic signal of the replaced roller component is obtained; based on the running characteristic signal of the previous roller component and the running characteristic signal of the replaced roller component, the continuity analysis of the previous roller component and the replaced roller component is conducted, and the continuity analysis result of roller components is obtained, it is possible to, on a basis of considering the influence of the running difference between the plurality of roller components on billet quality, consider the influence of the running performance difference between the previous roller component and the replaced roller component in the same position on the quality of the produced billet. At the same time, the performance and running state difference of the roller component before and after replacement can be well monitored, thus being beneficial to improving the reliability of the roller component and improving the quality of the produced billet.

In some embodiments, conducting control of the casting machine based on the running difference analysis result comprises: generating and sending alarm information where the running difference analysis result indicates that a certain roller component is in an abnormal synchronization state and/or an abnormal similarity state.

The specific meanings of the abnormal synchronization state and the abnormal similarity state are as described above, and will not be repeated here.

The alarm information can be, for example, text information, or alarm numbers or coded information, and the embodiments of the present disclosure is not limited by the specific composition and expression of the alarm information.

Based on the above, in the present application, by setting that alarm information is generated and sent under a condition where the running difference analysis result indicates that a certain roller component is in an abnormal synchronization state and/or an abnormal similarity state, the corresponding alarm information can be generated in time and notified to the user under the condition where a plurality of roller components are in inconsistent running. It is therefore beneficial to timely adjusting the running state of the roller component and conducting subsequent treatment, improving the reliability and stability of the system and improving the quality of the produced billet.

It should be understood that in addition to the running consistency among the plurality of roller components, the health status of a roller component itself also has an important influence on the quality of the finally produced billet, and may even lead to the sudden shutdown of the production line. In the current control system of a casting machine, due to the lack of predictive maintenance technology, it is impossible to automatically diagnose the health status of the roller components online in advance, and only after the failure occurs, the off-line daily data can be manually analyzed and the equipment dismantled to confirm the failed components.

Based on this, in some embodiments, the control method for casting machine further includes related processes of health management. For example, the control method further includes an abnormality detection process.

The abnormality detection process refers to a process of detecting whether there is abnormality in the running status of a roller component itself. FIG. 4 shows an exemplary flowchart of an abnormality detection process 110 according to an embodiment of the present disclosure.

Referring to FIG. 4, in the abnormality detection process 110, firstly, in step S111, for at least one roller component of the plurality of roller components, within a preset second detection time interval, the running characteristic signal of the roller component is acquired.

It should be understood that the preset second detection time interval can be specified by the user or preset by the system, for example. The embodiments of the present disclosure is not limited by the specific setting approach of the preset second detection time interval.

For example, the preset second detection time interval may be the same duration as the preset first detection time interval, or they may be different durations.

Thereafter, in step S112, performance characteristic data of the roller component is generated based on the running characteristic signal of the roller component.

The performance characteristic data refers to data representing the running performance of the roller component itself. The present disclosure is not limited by the specific composition of the performance characteristic data.

For example, the performance characteristic data can be obtained by processing the running characteristic signal. For example, if the performance characteristic data is the running torque signal of a roller component, for example, the running torque signal can be processed, and data such as signal peak value, mean value and variance of the running torque signal can be extracted as the performance characteristic data.

For example, if the running characteristic signal includes the running torque signal of the roller component and the rotational speed signal of the roller component, before generating the performance characteristic data of the roller component, for example, it also includes a process of preprocessing the running torque signal. Specifically, for example, it is known that the rotational speed signal value of the roller component is about 2-3 when the roller component does not rotate, and about 12-13 when the roller component rotates stably. At this time, for example, the data of the running torque signal of the roller component can be firstly screened based on the rotational speed signal of the roller component. Specifically, for example, in the running characteristic signal acquired in the second detection time interval, a target sub-period in which the rotational speed signal of the roller component is in the range of 12-13 is first determined, and then the running torque signal of the roller component corresponding to the target sub-period is taken as the target running torque signal, and in the subsequent processing, the performance characteristic data is determined based on the target running torque signal. Therefore, the selected target running torque signal can well characterize the performance characteristics of the roller component in the normal rotating state.

For example, process can be conducted based on the target running torque signal, such as determining the variance and peak value of the target running torque signal, and taking the variance and peak value as the performance characteristic data.

Thereafter, in step S113, the performance characteristic data is compared with a preset performance threshold range, and the running performance state of the roller component is determined based on the comparison result.

The preset performance threshold range is a performance characteristic data range used to define the roller component in the normal performance state. Specifically, the preset performance threshold range may include, for example, one or more sub-performance threshold ranges, for example, a variance threshold range and/or a peak threshold range according to actual needs.

The running performance state is intended to characterize whether the running performance of the roller component is normal or not. The running performance states include a normal running state and an abnormal running state.

The normal running state means that the rotation performance of the roller components is within the normal performance range, such as ranges of the expected peak value, mean value and variance. The abnormal running state means that the rotation performance of the roller components exceeds the normal performance range. For example, the roller component runs in a way that is too large, too small, or the change rate is too fast, or the running stability is too low.

For example, if the performance characteristic data of the roller component includes variance data and peak data, the variance data and peak data can then for example be compared with the variance threshold range and peak threshold range, respectively. If the variance data falls within the variance threshold range, it indicates that the roller component has a normal variance characteristic; or if the variance data does not fall within the variance threshold range, it indicates that the roller component has an abnormal variance characteristic. If the peak data falls within the peak threshold range, it indicates that the roller component has a normal peak characteristic; if the peak data does not fall within the peak threshold range, it indicates that the roller component has an abnormal peak characteristic. At this time, for example, when the roller component has an abnormal variance characteristic and/or an abnormal peak characteristic, it can be judged that the running performance state of the roller component is an abnormal running state.

Based on the above, in the present application, by further setting that the control method includes the process related to the health management of the roller components on the basis of analyzing the running difference among the plurality of roller components, that is, the control method being set to include an abnormality detection process of the roller components, it is possible that, on the basis of considering the synergy between the roller components, the influence of the abnormal running of the roller component itself on the billet quality is further considered, and the production quality of the billet is improved. In addition, compared with the current situation in which the health status cannot be automatically diagnosed online in advance, and in which only after the failure occurs, the off-line daily data can be analyzed manually and the equipment can be disassembled to confirm the situation of the failed components, in the present application, it is possible to realize the on-line automatic diagnosis process in time through the abnormality detection process, and the abnormality of the roller components can be found in time and handled accordingly, thus avoiding the extreme abnormality of the roller components, preventing the shutdown accidents caused thereby, and improving the service life and reliability of the roller components and the casting machine.

In some embodiments, the roller component includes a plurality of sub-components, and each sub-component further includes a plurality of sub-composing parts.

For example, the interior of the roller component can include a plurality of bearing sub-components (for example, four bearing components), and each bearing sub-component includes three sub-composing parts, for example, the bearing inner ring, the bearing outer ring and the bearing balls.

However, it should be understood that the above is only one example of the composition of the roller component, and the roller component can also have other composition structures according to actual needs. Embodiments of the present disclosure are not limited by the specific types of sub-components and sub-composing parts inside the roller components.

In a case where the roller component has a plurality of sub-components and sub-composing parts, not faults of all the sub-components or sub-composing parts can be reflected in the running performance characteristics of the roller component in real time, which leads to that in some cases, when the internal parts of the roller component fail, the roller component may still be able to run normally at this time, and the fault cannot be diagnosed in the abnormality detection process, such a fault will be ignored, resulting in potential safety hazards of the roller component.

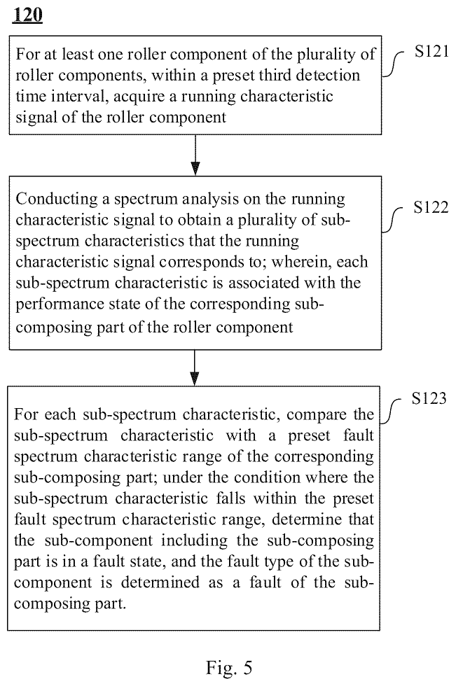

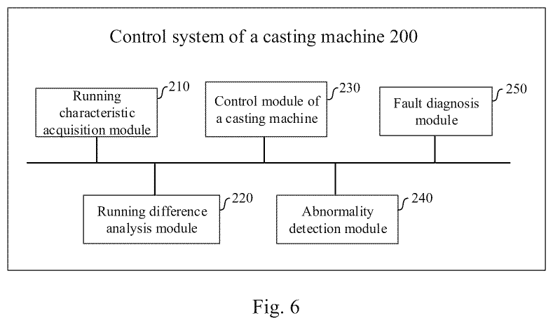

Based on this, in the present application, while the abnormality detection of the roller component is conducted, a fault diagnosis of the roller component can be further conducted at the same time. FIG. 5 shows a schematic flowchart of a fault diagnosis process 120 of a roller component according to an embodiment of the present disclosure.

Referring to FIG. 5, the fault diagnosis process 120 includes: firstly, in step S121, for at least one roller component of the plurality of roller components, within a preset third detection time interval, the running characteristic signal of the roller component is acquired.

It should be understood that the preset third detection time interval may be selected by the user or preset by the system, for example. The embodiments of the present disclosure is not limited by the generation approach of the preset third detection time interval.

It should be understood that the preset third detection time interval may be the same as the preset first detection time interval and the preset second detection time interval, or the first detection time interval, the preset second detection time interval and the preset third detection time interval may be different in duration. The embodiments of the present disclosure is not limited by the duration relationship between the preset third detection time interval and the preset first detection time interval and the preset second detection time interval.

For example, the running characteristic signal may include, for example, a running torque signal of the roller component.

After obtaining the running characteristic signal, in step S122, a spectrum analysis is conducted on the running characteristic signal to obtain a plurality of sub-spectrum characteristics that the running characteristic signal corresponds to; wherein each sub-spectrum characteristic is associated with the performance state of the corresponding sub-composing part of the roller component.

The spectrum analysis refers to the analysis process of spreading the running characteristic signal at different frequencies to obtain corresponding sub-signals or information (such as amplitude, power, intensity or phase, etc.).

The sub-spectrum characteristic refers to the running characteristic signal component corresponding to a specific frequency/frequency band obtained by expanding the running characteristic signal at the specific frequency or frequency band. The specific frequency or frequency band is, for example, a frequency or frequency band that reflects the performance state corresponding to a certain sub-composing part of the roller component.

Each sub-spectrum characteristic being associated with the performance state of the corresponding sub-composing part of the roller component means that the sub-spectrum characteristic under the specific frequency/frequency band can reflect the performance state of the sub-composing part corresponding to the specific frequency/frequency band.

For example, when the roller component has four bearings (sub-components), each bearing includes three sub-composing parts (i.e., 12 sub-composing parts in total), and the running characteristic signal is the running torque signal of the roller component, for example, the running characteristic signal can be expanded at 12 frequencies or frequency bands according to actual needs to obtain 12 sub-spectrum characteristics. Among them, the 12 frequency bands correspond to the 12 sub-composing parts respectively, and at this time, the obtained 12 sub-spectrum characteristics respectively represent the performance characteristics of the 12 sub-composing parts of the roller component.

After obtaining the sub-spectrum characteristics, in step S123, for each sub-spectrum characteristic, it is compared with a preset fault spectrum characteristic range of the corresponding sub-composing part.

The preset fault spectrum characteristic range refers to a spectrum range representing that the sub-composing part is in a fault state. For example, the preset fault spectrum characteristic range can be a single frequency, such as the aging frequency value of the sub-composing part, or it can also be multiple frequencies, such as including an aging frequency band.

And wherein, under a condition where the sub-spectrum characteristic falls within the preset fault spectrum characteristic range, it is determined that the sub-component including the sub-composing part is in a fault state, and the fault type of the sub-component is determined as the fault of the sub-composing part.

For example, if the roller component includes bearings (sub-components) Z1, Z2 and Z3, and the bearing Z1 includes three sub-composing parts Za1, Zb1 and Zc1, and the bearings Z2 and Z3 include one sub-composing part respectively, Za2 and Za3, then five sub-spectrum characteristics Pa1, Pb1, Pc1, Pa2 and Pa3 can be obtained from the running characteristic signal of the roller component through frequency spectrum analysis, which correspond to sub-composing parts Za1, Zb1, Zc1, Za2 and Za3 respectively. For example, for each sub-composing part, the failure frequency bands are obtained as Pa1_s, Pb1_s, Pc1_s, Pa2_s and PA3_s. At this time, for example, the respective sub-spectrum characteristic can be compared with the aging frequency band of the corresponding sub-composing part respectively. If, after comparison, the sub-spectrum characteristic Pb1 of the sub-composing part Zb1 falls into its failure frequency band Pb1_s, for example, the sub-component Z1 which the sub-composing part Zb1 corresponds to can be determined to be in a fault state, and the fault type of the sub-component Z1 can be determined to be a fault of the sub-composing part Zb1.

Base on the above, in the application, by setting that the control method of a casting machine further comprise a fault diagnosis process, so that the performance of the internal sub-components and sub-composing parts of the roller component can be further diagnosed, so that whether the respective sub-component in the roller component is in a fault state can be judged in time, and the fault type can be judged (that is, locating which sub-composing part in the sub-component is in fault), so that the performance state of the internal components of the roller component can be understood more comprehensively and concretely. On the one hand, without disassembling the whole equipment manually, the fault information inside the roller components can be identified simply and conveniently through spectrum analysis, which reduces the labor cost of fault identification and improves the real-time and reliability of fault identification. On the other hand, through fault diagnosis, it is possible to find the problems in time when the internal components of the roller components fail, and to replace the internal sub-composing parts in time, which effectively takes into account and supplements the problem that the internal faults of the roller components cannot be identified at the first time when only the overall running performance of the roller components is identified through abnormality process, and improves the safety and reliability when using the roller components.

It should be understood that the running difference analysis process, the abnormality detection process and the fault diagnosis process may be executed in a predetermined order, or in reverse order, or in parallel, for example. The embodiments of the present disclosure is not limited by the execution order of the running difference analysis process, the abnormality detection process and the fault diagnosis process.

According to another aspect of the present disclosure, a control system 200 for a casting machine is also proposed. As mentioned above, the casting machine includes a plurality of roller components and a plurality of motors that drive the plurality of roller components to rotate, and the motors are in one-to-one correspondence to the roller components.

FIG. 6 shows an exemplary block diagram of a control system 200 for a casting machine according to an embodiment of the present disclosure.

Referring to FIG. 6, the control system 200 for a casting machine includes an running characteristic acquisition module 210, a running difference analysis module 220, and a casting machine control module 230.

The running characteristic acquisition module 210 is configured to execute the process of step S101 in FIG. 1, and acquire the running characteristic signal of each roller component within a preset first detection time interval.

It should be understood that the preset first detection time interval refers to a preset time period for realizing roller detection, and the embodiments of the present disclosure is not limited by the specific duration of the preset first detection time interval.

The running characteristic signal of the roller component refers to a signal used to reflect the running state of the roller component. The running characteristic signal can be, for example, a signal of the torque subjected to by the roller component, or a rotational speed signal of the roller component, and can also include other signals according to actual needs.

The running difference analysis module 220 is configured to perform the process of step S102 in FIG. 1, and conduct running difference analysis on the plurality of roller components based on the running characteristic signal of each roller component to obtain the running difference analysis result.

The running difference analysis refers to the analysis of the running difference of the plurality of roller components, and the analysis aims to know whether the plurality of roller components have good running consistency (including time synchronization and/or running performance similarity) at present.

The running difference analysis result can indicate the roller components which are in inconsistent running state with other roller components, and the embodiments of the present disclosure is not limited by the specific expression form of the running difference analysis result.

The control module 230 for a casting machine is configured to execute the process of step S103 in FIG. 1, and conducting control on the casting machine based on the running difference analysis result.

For example, the running state of the roller components in inconsistent running state can be adjusted based on the running difference analysis result, or corresponding alarm information can be generated based on the running difference analysis result.

The running difference analysis includes at least one of a running synchronization analysis and a running similarity analysis.

The running synchronization analysis refers to an analysis for determining whether the rotations of the plurality of roller components are consistent in time domain, that is, whether they are synchronized in time. For example, it is judged whether the running time periods of the running characteristic signals of the plurality of roller components are the same, and whether the starting points and ending points of the rotation are basically the same.

The running similarity analysis refers to an analysis used to determine whether the running performances of the plurality of roller components have relatively large similarity, that is, whether the signal waveforms are related. For example, it is judged whether the similarity of the waveforms of the running characteristic signals of the plurality of roller components meets a preset requirement or not.

Based on the above, by setting that in the preset first detection time interval, the running characteristic signal of each roller component is obtained, and based on the running characteristic signal of each roller component, the running difference analysis of the plurality of roller components is conducted to obtain the running difference analysis result, so as to control the casting machine, the influence of difference of the plurality of roller components during the running process on the slab quality is fully considered, so that it is possible to flexibly and reliably realize the analysis on the running difference of the roller components, thereby adjusting the roller components in time, realizing good and reliable slab production and improving the quality of the produced slab. In addition, by setting that the running difference analysis includes at least one of a running synchronization analysis and a running similarity analysis, in the evaluation of roller running difference, the influence of running performance difference (and running similarity difference) and running time difference (that is, running synchronization difference) during the roller running process on the final slab quality is fully considered, so that various inconsistencies in roller running can be well detected, which is beneficial for timely treatment and adjustment, improving the reliability of the casting machine as well as the quality of the produced billets in all directions.

In some embodiments, the control system for a casting machine may further include, for example, an abnormality detection module 240, which is configured to perform the abnormality detection process 110 in the aforementioned FIG. 4

In some embodiments, the control system for a casting machine may further include, for example, a fault diagnosis module 250, which is configured to perform the fault diagnosis process 120 in the aforementioned FIG. 5.

In some embodiments, the control system for a casting machine can also perform the control method for a casting machine as described above, for example, and has the functions as described above, which will not be described in detail here.

According to another aspect of the present disclosure, a nonvolatile computer-readable storage medium is also provided, on which computer-readable instructions are stored, and when the instructions are executed by a computer, the computer can perform the method as described above and have the functions as described above.

The program part in the technology can be regarded as a “product” or “work” in the form of executable code and/or related data, which is participated in or realized by computer-readable media. Tangible, permanent storage media can include memory or storage device used by any computer, processor, or similar equipment or related modules. For example, various semiconductor memories, tape drives, disk drives, or any similar devices that can provide storage functions for software.

All software or a part of it may sometimes communicate through a network, such as the Internet or other communication networks. Such communication can load software from one computer device or processor to another. For example, a hardware platform loaded into a computer environment from a server or a host computer of a device, or other computer environments that implement the system. Therefore, another medium that can transmit software elements can also be used as a physical connection between local devices, such as light waves, electric waves, electromagnetic waves, etc., which realize communication through cables, optical cables or air. Physical media used for carry waves, such as cables, wireless connections or optical cables, can also be considered as media for carrying software. Unless the usage here is limited to tangible “storage” media, other terms referring to computer or machine “readable media” refer to media that participate in the execution of any instructions by a processor.

The application uses specific words to describe the embodiments of the application. Words such as “the first/second embodiment”, “an embodiment” and/or “some embodiments” mean a certain feature, structure or characteristic related to at least one embodiment of the present application. Therefore, it should be emphasized and noted that two or more references to “an embodiment” or “one embodiment” or “an alternative embodiment” in different places in this specification do not necessarily refer to the same embodiment. In addition, some features, structures or characteristics in one or more embodiments of the present application can be appropriately combined.

In addition, those skilled in the art can understand that various aspects of the present application can be illustrated and described by several patentable categories or situations, including any new and useful process, machine, product or substance combination, or any new and useful improvement on them. Accordingly, various aspects of the present application can be completely executed by hardware, completely executed by software (including firmware, resident software, microcode, etc.), or executed by a combination of hardware and software. All the above hardware or software can be called “data block”, “module”, “engine”, “unit”, “component” or “system”. Furthermore, various aspects of the present application may be embodied as a computer product in one or more computer-readable media, which product includes computer-readable program code.

Unless otherwise defined, all terms (including technical and scientific terms) used herein have the same meaning as commonly understood by those of ordinary skills in the art to which the present disclosure belongs. It should also be understood that terms such as those defined in general dictionaries should be interpreted as having meanings consistent with their meanings in the context of the related art, and should not be interpreted in an idealized or extremely formal sense unless explicitly defined herein.

The above is an explanation of the present disclosure, and should not be considered as a limitation. Although several exemplary embodiments of the present disclosure have been described, those skilled in the art will easily understand that many modifications can be made to the exemplary embodiments without departing from the novel teaching and advantages of the present disclosure. Therefore, all these modifications are intended to be included within the scope of the present disclosure as defined by the claims. It should be understood that the above is a description of the present disclosure, and it should not be considered as limited to the specific embodiments disclosed, and modifications to the disclosed embodiments and other embodiments are intended to be included within the scope of the appended claims. The present disclosure is defined by the claims and their equivalents.

What is claimed is:

1. A control method for a casting machine, the casting machine comprising a plurality of roller components and a plurality of motors for driving the plurality of roller components to rotate, wherein motors are in one-to-one correspondence with the roller components, and the method comprises:
acquiring, within a preset first detection time interval, a running characteristic signal of each roller component;
conducting, based on the running characteristic signal of each roller component, a running difference analysis of the plurality of roller components to obtain a running difference analysis result;
conducting, based on the running difference analysis result, control on the casting machine;
wherein the running difference analysis comprises at least one of a running synchronization analysis and a running similarity analysis.

2. The control method for a casting machine according to claim 1, wherein the running characteristic signal of the roller component comprises a running torque signal of the roller component and a rotational speed signal of the roller component.

3. The control method for a casting machine according to claim 1, wherein the running synchronization analysis comprises:
for each of the plurality of roller components:
conducting a time domain analysis on the running characteristic signal of the roller component to determine running time domain deviation data of the roller component;
determining, based on the running time domain deviation data of the roller component and a preset deviation threshold, a running synchronization state of the roller component, and obtaining a synchronization analysis result;
and wherein the running synchronization state is a normal synchronization state or an abnormal synchronization state.

4. The control method for a casting machine according to claim 1, wherein the running similarity analysis comprises:
for each of the plurality of roller components:
performing a waveform analysis on the running characteristic signal of the roller component to determine running similarity data of the roller component;
determining, based on the running similarity data of the roller component and a preset similarity threshold, a running similarity state of the roller component to obtain a similarity analysis result;
and wherein the running similarity state is a normal similarity state or an abnormal similarity state.

5. The control method for a casting machine according to claim 1, wherein the control method of a casting machine further comprises a continuity analysis of roller components:
acquiring, after a certain roller component is replaced, within a preset first detection time interval, a running characteristic signal of the replaced roller component;
conducting, based on the running characteristic signal of the previous roller component and the running characteristic signal of the replaced roller component, a continuity analysis of the previous roller component and the replaced roller component, and obtaining a continuity analysis result of the roller components.

6. The control method for a casting machine according to claim 1, wherein conducting control on the casting machine based on the running difference analysis result comprises:
generating and sending alarm information under a condition where the running difference analysis result indicates that a certain roller component is in an abnormal synchronization state and/or an abnormal similarity state.

7. The control method for a casting machine according to claim 1, further comprising an abnormality detection process, the abnormality detection process comprising:
for at least one roller component of the plurality of roller components:
acquiring, within a preset second detection time interval, a running characteristic signal of the roller component;
generating, based on the running characteristic signal of the roller component, performance characteristic data of the roller component;
comparing the performance characteristic data with a preset performance threshold range, and determining a running performance state of the roller component based on the comparison result;
wherein the running performance state comprises a normal running state and an abnormal running state.

8. The control method for a casting machine according to claim 1, wherein the roller component comprises a plurality of sub-components, and each sub-component further comprises a plurality of sub-composing parts; and the method further comprise a fault diagnosis process, the fault diagnosis process comprising:
for at least one roller component of the plurality of roller components:
acquiring, within a preset third detection time interval, a running characteristic signal of the roller component;
performing a spectrum analysis on the running characteristic signal to obtain a plurality of sub-spectrum characteristics corresponding to the running characteristic signal; wherein each sub-spectrum characteristic is associated with a performance state of the corresponding sub-composing part of the roller component;
comparing, for each sub-spectrum characteristic, the sub-spectrum characteristic with a preset fault spectrum characteristic range of the corresponding sub-composing part;
determining, under a condition where the sub-spectrum characteristic falls within the preset fault spectrum characteristic range, that the sub-component comprising the sub-composing part is in a fault state, and determining the fault type of the sub-component as a fault of the sub-composing part.

9. A control system for a casting machine, the casting machine comprising a plurality of roller components and a plurality of motors driving the plurality of roller components to rotate, wherein the motors are in one-to-one correspondence with the roller components, and the system comprises:
a running characteristic acquisition module configured to acquire a running characteristic signal of each roller component within a preset first detection time interval;
a running difference analysis module configured to conduct a running difference analysis on the plurality of roller components based on the running characteristic signal of each roller component to obtain a running difference analysis result;
a casting machine control module configured to conduct control on the casting machine based on the running difference analysis result;
wherein the running difference analysis comprises at least one of a running synchronization analysis and a running similarity analysis.

10. A computer-readable storage medium comprising instructions stored on the computer-readable storage medium, and when the instructions are executed by a computer, the method according to claim 1 is executed.

11. A computer-readable storage medium comprising instructions stored on the computer-readable storage medium, and when the instructions are executed by a computer, the method according to claim 8 is executed.
